(19) United States
(12) Patent Application Publication
(10) Pub. No.: US 2014/0178536 A1
(43) Pub. Date: Jun. 26, 2014

(54) ICING OR COATING COMPOSITION

(71) Applicant: LODERS CROKLAAN USA LLC, Channahon, IL (US)

(72) Inventors: Gerald Patrick McNeill, Channahon, IL (US); Anthony George Herzing, Channahon, IL (US); Donna Cindy Studenka, Channahon, IL (US)

(73) Assignee: LODERS CROKLAAN USA LLC, Channahon, IL (US)

(21) Appl. No.: 13/726,529

(22) Filed: Dec. 24, 2012

(51) Int. Cl. A23G 3/34

(52) U.S. Cl. CPC A23G 3/343
USPC 426/103; 426/659; 426/631; 426/607; 426/519; 426/302

(57) ABSTRACT

An icing or coating composition for edible products comprises at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid.

This invention relates to an icing or coating composition for edible products such as baked goods including snack items such as biscuits, cookies and cakes.

A coating or icing is sometimes applied to food products such as sugar-containing baked goods. The coating or icing is often a mixture comprising fat and sugar. Chocolate-like coatings and icings typically also contain cocoa powder to give the colour and taste of chocolate.

There is a desire amongst many consumers to reduce the quantity of saturated fat in the diet. However, since saturated fat contributes to the physical and organoleptic properties of the coating or icing, replacing saturated fat can be technically challenging. This is particularly so when an icing or coating must meet other requirements such as setting relatively quickly and remaining flexible so that the icing or coating does not crack when the iced or coated product is subjected to minor mechanical shock during handling or transport.

U.S. Pat. No. 7,645,473 discloses a vegetable fat composition that can be used in an icing composition for baked goods. The presence of a liquid oil is optional and in the examples 36% liquid oil is used in the composition.

WO 2004/112492 describes a process for the production of a fat composition suitable for use as a confectionery fat, wherein a starting fat composition which contains between 20 and 95 wt % of S2U, less than 75 wt % of SU2+U3, less than 20 wt % of S3 between 1 and 12 wt % of diglycerides, between 10 and 100 wt % of at least one interesterified fat, the interesterified fat containing less than 15 wt % of C-12 with respect to the total amount of interesterified fat, is subjected to a catalytic hydrogenation so as to obtain a first fat and in that the first fat is incorporated in the fat composition.

US 2008/0206413 describes a puff pastry preparation containing a fat which principally comprises palm olein, preferably interesterified.

WO 2009/012888 also relates to a laminating fat for use in dough such as puff pastry.

There remains a need for icing and coating compositions that have a low saturated fatty acid (SAFA) content but that can provide an organoleptically acceptable, flexible coating for edible products having an acceptable setting time, particularly for baked goods including baked confectionery snack items such as biscuits, cookies and cakes.

According to the invention, there is provided an icing or coating composition for edible products comprising at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid.

Also provided by the invention is an iced or coated edible product comprising a base product and an icing or coating, wherein the icing or coating is a composition of the invention.

Also provided by the invention is a fat blend, suitable for the production of a coating or icing composition, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid.

A further aspect of the invention is the use of a composition comprising at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid, as an icing or coating on an edible product.

In another aspect, the invention provides a method of making an icing or coating composition comprising at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid, which comprises mixing the sugar and the fat blend at a temperature of from 45 to 100° C. and refining the mixture.

In yet another aspect, the invention provides a method of forming an icing or coating on an edible product which comprises applying to the edible product a composition comprising at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid, at a temperature of from 40 to 60° C.

In addition to providing a flexible coating for edible products, the invention involves a reduction the saturated fatty acid (SAFA) content of an icing or coating composition. Preferably, the saturated fatty acid (SAFA) content of the composition is less than 43% by weight, such as from 35 to 40% by weight, based on the total C12 to C24 fatty acids present. It will be appreciated that the SAFA content is based on the fatty acids that are present as fatty acyl groups in glycerides in the composition and in the fat blend it contains.

The monounsaturated fatty acid (MUFA) content of the fat blend is preferably in the range of from 42 to 50% by weight based on the total C12 to C24 fatty acids present. The polyunsaturated fatty acid (PUFA) content of the fat blend is preferably from 10 to 20% by weight based on the total C12 to C24 fatty acids present. Again, these are based on the fatty acids that are present as fatty acyl groups in glycerides in the composition and in the fat blend it contains.

The fat blend comprises from 12 to 25% by weight SOO and from 7 to 15% SOL based on the total weight of triglycerides present in the fat blend. S is saturated fatty acid having 12 to 24 carbon atoms, O is oleic acid and L is linoleic acid. SOO refers to a triglyceride having S at the 1-position and O at the 2- and 3-positions of the glycerol moiety. SOL refers to a triglyceride having S at the 1-position, O at the 2-position and L at the 3-position of the glycerol moiety. Those skilled in the art will understand that the numbering of the 1- and 3-positions may be exchanged.

Preferably, the fat blend comprises from 14 to 20% by weight SOO based on the total weight of triglycerides present. Additionally or alternatively, the fat blend may comprise 8 to 14% by weight SOL based on the total weight of triglycerides present.

The fat blend of the invention preferably comprises from 10 to 25% by weight of a liquid oil and from 75 to 90% by weight of a palm oil olein. More preferably, the fat blend comprises from 12 to 20% by weight liquid oil and from 80 to 88% by weight palm oil olein. In one preferred embodiment, the fat blend may contain only the liquid oil and the palm oil olein, in other words, the fat blend may consist of from 10 to 25% by weight of a liquid oil and from 75 to 90% by weight of a palm oil olein or from 12 to 20% by weight liquid oil and from 80 to 88% by weight palm oil olein.

Palm oil olein is obtained as a lower melting point fraction by the fractionation of palm oil. Fractionation of fats and oils into higher and lower melting fractions is a technique that is well-known to those skilled in the art. The higher melting fraction is usually termed a stearin and the lower melting fraction is usually called an olein. Fractionation may be carried out in the presence of a solvent (wet) or without a solvent (dry).

The palm oil olein is preferably interesterified. Interesterification randomises the fatty acid residues in the glycerides. Interesterification may be carried out chemically using catalysts, such as bases (e.g., sodium methoxide) or enzymatically using a lipase. Preferably, the palm oil olein is chemically interesterified.

The optionally interesterified palm oil olein preferably has an iodine value (IV) of from 45 to 65. The palm oil olein will have the same, or substantially the same, IV before interesterification. Iodine value may be determined by AOCS Cd 1d-92.

Liquid oils are vegetable oils that are liquid at room temperature (20° C.) and include canola oil, soybean oil, sunflower oil, cotton seed oil, ground nut oil, safflower oil and mixtures thereof. Preferably, the liquid oil comprises canola oil, typically in an amount of at least 75% by weight. More, preferably, the liquid oil consists of canola oil.

The physical properties of fats are sometimes defined in terms of N values. These indicate the percentage of solid fat in the composition at a given temperature. Thus, the term Nx refers to solid fat content at a temperature of x ° C., measured by NMR pulse techniques. Methods for determining N values are NEN-ISO method 8292-1 or AOCS Cd 16b-93.

The fat blend of the invention preferably has one or more of the following N-values:

N10 of greater than 35, more preferably from 38 to 50
N20 of greater than 20, more preferably 20 to 30,
N25 of less than 16, more preferably less than 15 and
N30 of less than 12, more preferably less than 10.

Preferably, the fat blend has an N10 of greater than 35, an N20 of greater than 20, an N25 of less than 16 and an N30 of less than 12.

Preferably, the fat blend comprises palmitic acid in an amount of greater than 32% and/or stearic acid in an amount of from 3.5 to 5%, based on the total C12 to C24 fatty acids present.

The term fatty acid, as used herein, refers to straight chain saturated or unsaturated (including mono- and poly-unsaturated) carboxylic acids having from 12 to 24 carbon atoms. The term is used herein to refer to the carboxylic acid residues bound to the glycerol moiety as acyl groups in glycerides. The fat blend preferably comprises at least 95% by weight fatty acids, more preferably at least 98% fatty acids, based on total carboxylic acids present as acyl groups.

The fat blend used in the composition of the invention preferably comprises palmitic, stearic, oleic and linoleic acids in an amount of at least 85% by weight, more preferably at least 90% by weight, based on the total fatty acids present in the fat blend.

The fat blend preferably comprises linolenic acid in an amount of less than 3% by weight, more preferably less than 2% by weight based on total fatty acids present in the fat blend.

The fat blend used in the composition of the invention preferably contains less than 2% by weight of arachidic and behenic acid residues based on total fatty acids present in the fat blend. More preferably, the fat blend contains less than 1% by weight of arachidic and behenic acid residues based on total fatty acids present in the fat blend.

The fat blend preferably has at least 80%, more preferably at least 85%, by weight of triglycerides having carbon numbers of 50, 52 and 54. Preferably, at least 90%, more preferably at least 95% by weight of the triglycerides in the fat blend have carbon numbers of 48, 50, 52 and 54. It is thus preferred that less than 10%, more preferably, less than 5%, by weight of the triglycerides in the fat blend have a carbon number of 46 or less. Preferably, less than 9%, more preferably less than 8%, by weight of the triglycerides in the fat blend have a carbon number of 48. Carbon number is the total number of carbon atoms from fatty acids in a triglyceride—for example, tripalmitin (tripalmitoyl glycerol) will have a carbon number of 3×16=48.

The fat blend of the invention has typically not undergone hydrogenation. Thus, the fat blend is preferably non-hydrogenated. The fat blend is therefore substantially free of trans fatty acids i.e., it contains less than 1%, more typically less than 0.8%, by weight trans fatty acids based on the total fatty acids present in the fat blend.

The fat blend preferably has an iodine value (IV) of from 55 to 75. Again, iodine value may be determined by AOCS Cd 1d-92.

The icing or coating composition of the invention comprises sugar. Sugars include, for example, sucrose, glucose, fructose and mixtures thereof. The sugar is typically sucrose. The sugar is preferably powdered.

Preferably, the sugar is present in the composition of the invention in an amount of from 30 to 70% by weight, more preferably from 40 to 60% by weight, even more preferably from 45 to 55% by weight, based on the weight of the composition.

The composition of the invention preferably comprises the fat blend in an amount of from 20 to 45% by weight, such as from 30 to 35% by weight.

The compositions of the invention optionally comprise, in addition to the fat blend and the sugar, one or more components selected from flavourants, emulsifiers and colourants. Typically, these components will be present in an amount of up to 20% by weight of the composition. Examples of flavourants and colourants include cocoa powder, non-fat dry milk (NFDM) powder and vanillin. Lecithin is a preferred emulsifier and is preferably present in an amount of up to 1% by weight of the composition, such as from 0.1 to 1% by weight. It is preferred that the composition comprises cocoa powder, more preferably in an amount of up to 15% by weight of the composition, such as from 1 to 15% by weight.

It will be appreciated that the percentage amounts of all of the components in the composition of the invention will add up to 100%.

The compositions are typically used to apply an icing or a partial or complete coating to a base product which is preferably a baked product, more preferably a baked confectionery product. An icing will usually be applied to the top of the base product, whereas a coating will usually be applied to all, or substantially all, of the base product. Baked products are typically baked in an oven. Examples of baked confectionery products include biscuits, cookies and cakes. Cupcakes are particularly preferred examples of baked confectionery products for the invention.

One preferred embodiment of a composition of the invention is an icing or coating composition for edible products comprising from 30 to 70% by weight sugar and from 20 to 45% by weight of a fat blend, wherein the fat blend wherein the fat blend comprises from 14 to 20% by weight SOO and from 7 to 15% SOL based on the total weight of triglycerides present and the fat blend has a saturated fatty acid content of less than 43% by weight based on the total C12 to C24 fatty acids present and a monounsaturated fatty acid content in the range of from 42% to 50% by weight based on the total C12 to C24 fatty acids present, and wherein S is saturated fatty acid having 12 to 24 carbon atoms, O is oleic acid and L is linoleic acid, and the fat blend has an N30 of less than 12.

Another preferred embodiment of a composition of the invention is an icing or coating composition for baked confectionery products comprising from 30 to 70% by weight sugar, from 20 to 45% by weight of a fat blend, from 0.1 to 1% by weight lecithin and from 1 to 15% by weight cocoa powder, wherein the fat blend wherein the fat blend comprises from 14 to 20% by weight SOO and from 8 to 14% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid and the fat blend comprises from 10 to 25% by weight of a liquid oil comprising canola oil and from 75 to 90% by weight of an interesterified palm oil olein having an IV of from 45 to 65.

A further preferred embodiment of a composition of the invention is an icing or coating composition for baked confectionery products comprising from 40 to 60% by weight sugar, from 20 to 45% by weight of a fat blend and from 1 to 15% by weight cocoa powder, wherein the fat blend wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid and the fat blend consists of from 10 to 25% by weight of canola oil and from 75 to 90% by weight of an interesterified palm oil olein.

The method of the invention for making an icing or coating composition of the invention preferably comprises mixing the sugar and the fat blend at a temperature of from 45 to 100° C. and refining the mixture. Typically, at least a portion of the fat blend is melted and added to at least the particulate ingredients (such as sugar, cocoa powder and milk powder) with stirring. The resulting mixture is then subjected to a refining step. Refining is a term that is well-known to those skilled in the art and refers to reducing the particle size of the particulates present in a composition so as to improve mouthfeel, by avoiding a gritty texture. In the refining step, the particle size of the sugar and any other particulate components is reduced. A suitable refiner is a 3-roll refiner. Any remaining non-particulate ingredients (such as emulsifier) are preferably then added together with any remaining fat. The resulting mixture is preferably mixed for around 5 minutes to 2 hours.

The method of applying an icing or coating to an edible product according to the invention comprises applying the composition of the invention to the base edible product at a temperature of from 40 to 60° C. The composition is typically applied by dipping or coating onto the edible product. Preferably, the composition is applied in a continuous process to individual items of the edible product on a conveyor, such as a conveyor belt. The coated or iced product is then cooled. A typical rate of passage of the conveyor is less than 1.1 m per minute.

It will be appreciated that the icing or coating composition of the invention should exhibit no noticeable flow at temperatures of 25° C. over a time of up to 48 hours.

The following non-limiting examples illustrate the invention and do not limit its scope in any way. In the examples and throughout this specification, all percentages, parts and ratios are by weight unless indicated otherwise.

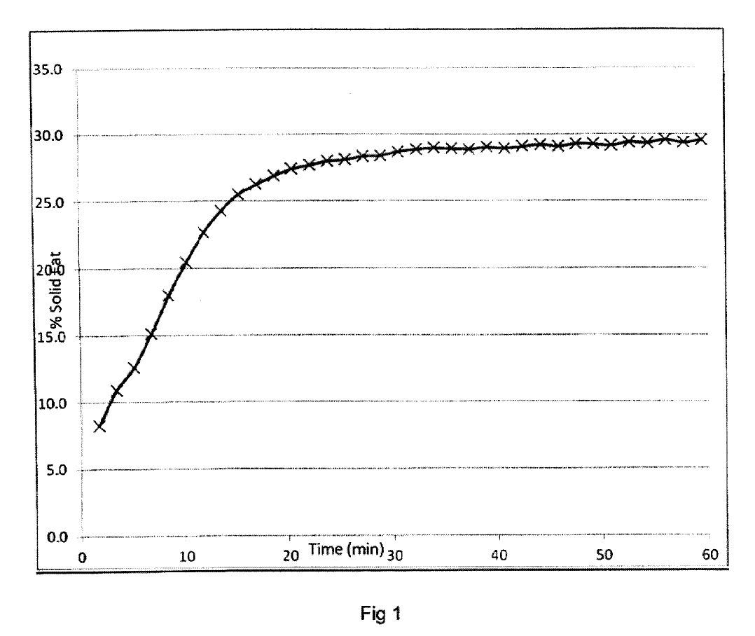

FIG. 1 shows a crystallization curve for the fat blend of Example 1.

### EXAMPLES

### Example 1

### Example 1A—Fat Blend

A fat blend was prepared by blending 84% by weight of chemically interesterified palm oil olein having an iodine value (IV) of 55 (Sans Trans HF from Loders Croklaan USA LLC) with 16% by weight canola oil.

The following analytical results were obtained for the fat blend:

| | |
|---|---|
| IV | 65.1 |
| Melting | 38.4 |
| point | |
| (° C.) | |
| N10 | 40.9 |
| N20 | 22.4 |
| N25 | 14.9 |
| N30 | 9.4 |
| N35 | 5.1 |
| N40 | 3.3 |
| FFA* | 0.04 |
| PV** | 1.3 |
| SAFA | 39.4 |
| MUFA | 46.2 |
| PUFA | 13.8 |
| TRANS | 0.7 |

*free fatty acids;
**peroxide value

The fatty acid composition was determined as follows:

| | | | |
|---|---|---|---|
| C6:0 | 0.0 | C32 | 0.0 |
| C8:0 | 0.0 | C34 | 0.0 |
| C10:0 | 0.0 | C36 | 1.4 |
| C12:0 | 0.3 | C38 | 1.0 |
| C14:0 | 0.9 | C40 | 0.0 |
| C16:0 | 33.8 | C42 | 0.0 |
| C16:1 | 0.2 | C44 | 0.0 |
| C17:0 | 0.1 | C46 | 1.0 |
| C18:0 | 3.9 | C48 | 7.8 |
| C18:1t | 0.0 | C50 | 26.1 |
| C18:1c | 45.7 | C52 | 35.5 |
| C18:2t | 0.4 | C54 | 27.2 |
| C18:2c | 12.2 | | |
| C18:3t | 0.3 | | |
| C18:3c | 1.6 | | |
| C20:0 | 0.3 | | |
| C20:1 | 0.3 | | |
| C22:0 | 0.1 | | |
| C22:1 | 0.0 | | |
| C24:0 | 0.1 | | |
| Total | 100.0 | Total | 100.0 |

A crystallization curve for the fat blend is shown in FIG. 1.

The fat blend contained the following triglycerides:

| | % |
|---|---|
| SOS | 6.4 |
| SOO | 16.9 |
| OSO | 8.63 |
| SSS | 9.8 |
| SLS | 1.8 |
| SSL | 4.7 |
| SOL | 9.8 |
| OOO | 12.9 |
| 3plus* | 14.1 |
| SSO | 14.9 |

*triglycerides having 3 or more double bonds

### Example 1B—Coating Formulation

A coating formulation was prepared from the fat blend as follows:

### Coating Formula:

| Example 1 | | | 1200 |
|---|---|---|---|
| Ingredient | Supplier | % | weight (g) |
| Powdered Sugar | Milliana | 48.0 | 576.0 |
| Teton Cocoa powder | Blommer | 4.5 | 54.0 |
| Natural Cocoa Powder | Barry Callebaut | 4.5 | 54.0 |
| High Heat NFDM Powder | Dawn | 9.0 | 108.0 |
| Fat blend - Example 1A | | 33.5 | 402.0 |
| Lecithin | Loders | 0.45 | 5.4 |
| | Croklaan | | |
| E. Vanillin | Rhodia | 0.05 | 0.6 |
| TOTAL | | 100.0 | 1200.0 |

The coating was prepared according to the following protocol:

1.) Turn on water bath temperature on the mixer and set at 150 to 160° F. (65 to 70° C.)
2.) Weigh out the sugar, cocoa powder and milk powder together in a Hobart bowl, and then blend for 5 minutes, on 1st speed.
3.) Add approximately one half of the melted fat until the mixture just comes together, but not wet, paste-like. Turn off the mixer.
4.) Take the mixture to the refiner and run once through the 3 roll refiner.
5.) Place refined mass in a clean Hobart bowl and add the E. vanillin, lecithin, and about one half of the remaining fat to the mass.
6.) Mix on 1st speed for 3 to 5 minutes, then stop the mixer, scrape the bowl and change to 2nd speed.
7.) Mix on 2nd speed for 5 minutes or until the mixture is smooth. Stop mixer. Scrape bowl and change back to 1st speed.
8.) Add the remaining fat and mix until desired “conching” effect is achieved. Conching time is usually from 30 to 60 minutes.

### Example 2

The coating composition was applied to cupcakes in a cooling tunnel.
The speed of the cooling tunnel was measured using a tachometer.
The length of the cooling is 19.7 ft (6 m).
The fastest speed of the belt is 6.6 ft/min (2 m/min), or 3 minutes in the tunnel.
The cooling tunnel has 3 temperature zones; for this experiment, all zones were set at the same temperature, 40-42 F (4-6° C.).
Fans/wind speed set at 10/8/10, respectively in zones 1, 2, and 3.
The coating was heated to 115° F. (46.1° C.).
Mini cupcake tops were dipped in the coating and shaken for 5 seconds and placed onto the cooling tunnel belt.

The first cupcakes were tacky, still slightly wet at the end of the tunnel with a belt speed of 4.2 ft/min (1.28 m/min) or 4.6 minutes in the cooling tunnel.

The belt speed was reduced to 3.6 ft/min (1.1 m/min) or 5.5 minutes in the tunnel and the cupcakes were slightly tacky.

Again, the belt speed was reduced to 3.5 ft/min (1.07 m/min) or 5.6 minutes in the tunnel and coating was set, not tacky.

| | | |
|---|---|---|
| 4.2 ft/min | 3.6 ft/min | 3.5 ft/min |
| (1.28 m/min) | (1.1 m/min) | (1.07 m/min) |
| 4.6 min | 5.5 min | 5.6 min |
| Slightly wet/tacky | Slightly tacky | Coating set |

1. An icing or coating composition for edible products comprising at least 30% by weight sugar and at least 20% by weight of a fat blend, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid.

2. Composition as claimed in claim 1, wherein the fat blend comprises from 14 to 20% by weight SOO based on the total weight of triglycerides present.

3. Composition as claimed in claim 1 wherein the saturated fatty acid content of the composition is less than 40% by weight.

4. Composition as claimed in claim 1, wherein the fat blend has one or more of: an N10 of greater than 35, an N20 of greater than 20, an N25 of less than 16 and an N30 of less than 12.

5. Composition as claimed in claim 1 wherein the fat blend comprises palmitic acid in an amount of greater than 32% and stearic acid in an amount of from 3.5 to 5%, based on the total C12 to C24 fatty acids present.

6. Composition as claimed in claim 1 wherein the sugar is present in the composition in an amount of from 30 to 70% by weight.

7. Composition as claimed in claim 1 wherein the fat blend is present in the composition in an amount of from 20 to 45% by weight.

8. Composition as claimed in claim 1 which further comprises cocoa powder.

9. Composition as claimed in claim 1 wherein the fat blend comprises from 10 to 25% by weight of a liquid oil and from 75 to 90% by weight of a palm oil olein.

10. Composition as claimed in claim 9, wherein the palm oil olein is interesterified.

11. Composition as claimed in claim 9, wherein the palm oil olein has an iodine value (IV) of from 45 to 65.

12. Composition as claimed in claim 9 wherein the liquid oil comprises canola oil.

13. A fat blend, suitable for the production of a coating or icing composition as claimed in claim 1, wherein the fat blend comprises from 12 to 25% by weight SOO and from 7 to 15% SOL based on the total weight of triglycerides present and the fat blend has a saturated fatty acid content of less than 45% by weight based on the total C12 to C24 fatty acids present and a monounsaturated fatty acid content in the range of from 40% to 60% by weight based on the total C12 to C24 fatty acids present, and wherein S is saturated fatty acid having 12 to 24 carbon atoms, O is oleic acid and L is linoleic acid.

14. An iced or coated edible product comprising a base product and an icing or coating, wherein the icing or coating is a composition as defined in claim 1.

15-16. (canceled)

17. Method of making an icing or coating composition as defined in claim 1, which comprises mixing the sugar and the fat blend at a temperature of from 45 to 100° C. and refining the mixture.

18. Method of forming an icing or coating on an edible product which comprises applying to the edible product the composition of claim 1 at a temperature of from 40 to 60° C.

19. Method as claimed in claim 18, wherein the edible product is a baked confectionery product.

20. Method as claimed in claim 18, wherein the edible product is selected from the group consisting of biscuits, cookies and cakes.
